(19) United States
(12) Patent Application Publication
(10) Pub. No.: US 2011/0216540 A1
(43) Pub. Date: Sep. 8, 2011

(54) LAMP LIGHT DIRECTOR REFLECTOR

(76) Inventor: John McCafferty, JR., San Dimas, CA (US)

(21) Appl. No.: 13/039,953

(22) Filed: Mar. 3, 2011

Related U.S. Application Data
(60) Provisional application No. 61/310,861, filed on Mar. 5, 2010.

(51) Int. Cl. F21V 17/02; F21V 7/00

(52) U.S. Cl. 362/282; 362/347

(57) ABSTRACT

A lamp light director reflector (LLDR) for being installed on a lamp having a light bulb including a housing having a convex exterior surface and a convex reflective interior surface; a hole on a top portion of the exterior surface configured to accommodate a harp nut base of the lamp therein, in a first position; and a slit on the top portion of the exterior surface configured to accommodate a harp of the lamp therein, in a second position wherein the housing is configured to be installed on the lamp such that the reflective interior surface faces the light bulb of the lamp. The first position is at a top of the lamp harp resting upon the harp, and the lamp harp passes through the slit in the second position resting atop the lamp bulb.

This Patent Application claims the benefits of U.S. Provisional Patent Application Ser. No. 61/310,861, filed on Mar. 5, 2010 and entitled “Lamp Light Director Reflector,” the entire content of which is hereby expressly incorporated by reference.

### FIELD OF THE INVENTION

The present invention relates to a director reflector for a household, office, store, etc. lamp .

### BACKGROUND

Typical household/office/store lamps are designed to provide lighting. If a user needs higher intensity of light, his/her only option is to increase the bulb wattage or use more lamps. However, the higher wattage of the bulb used increases the cost of operation through higher energy requirements of the light bulb. Lamp reflectors such as those used for flashlights, recessed lighting, spot lights, automobile headlights and portable lighting have been around for many years. However, the bulb used for flashlights/recessed lighting/spot lights/automobile headlights/portable lighting requires the bulb bottom (screw end portion) going through a hole in the reflector and screwing into a socket.

### SUMMARY

In some embodiments, the present invention is a lamp light director reflector (LLDR) for being installed on a lamp having a light bulb. The LLDR includes a housing having a convex exterior surface and a convex reflective interior surface; a hole on a top portion of the exterior surface configured to accommodate a harp nut base of the lamp therein, in a first position; and a slit on the top portion of the exterior surface configured to accommodate a lamp harp of the lamp therein, in a second position wherein the housing is configured to be installed on the lamp such that the reflective interior surface faces the light bulb of the lamp, wherein the first position is at a top of the lamp harp resting upon the harp, and wherein the lamp harp passes through the slit in the second position resting atop the lamp bulb.

In some embodiments, the present invention is a lamp light director reflector (LLDR) for being installed on a lamp having a light bulb. The LLDR includes a housing substantially in a half-sphere shape and having an exterior surface and a reflective interior surface; a hole on a top portion of the exterior surface configured to accommodate the harp nut base of the lamp and a slit on the top portion of the exterior surface including the hole and configured to accommodate the harp of the lamp therein, wherein the housing is configured to be installed on the lamp such that the reflective interior surface faces the light bulb of the lamp, and wherein the slit and hole are configured to allow the lamp light director reflector to slide up or down the lamp harp.

The housing may be substantially made of aluminum, steel, copper, plastic, and/or glass, with a reflective surface.

### BRIEF DESCRIPTION OF THE DRAWINGS

FIG. 1A shows a side view of a lamp with LLDR installed at the bottom position on a lamp harp, according to some embodiments of the present invention.

FIG. 1B shows a side view of a lamp with LLDR installed at the bottom position on a lamp harp and resting on top of the lamp bulb, according to some embodiments of the present invention.

FIG. 1C shows a side view of the lamp with 180 degrees turn compared to FIGS. 1A and 1B, according to some embodiments of the present invention.

FIG. 1D shows a side view of a lamp with LLDR installed at a top position, according to some embodiments of the present invention.

FIG. 1E shows a side view of the lamp of FIG. 1D with 180 degrees turn, according to some embodiments of the present invention.

FIG. 2A shows a horizontal side view of an exemplary LLDR, according to some embodiments of the present invention.

FIG. 2B shows a top view of an exemplary LLDR, according to some embodiments of the present invention.

FIG. 2C shows a vertical side view of an exemplary LLDR, according to some embodiments of the present invention.

FIGS. 3A-3D show an exemplary installation of a LLDR on a lamp, according to some embodiments of the present invention.

### DETAILED DESCRIPTION

In some embodiments, the present invention is a lamp light director reflector (LLDR) that is easily installed on a lamp using a lamp harp in different selectable positions to increase the light intensity of the lamp to the base of the lamp by reflecting a large portion of the light from the lamp.

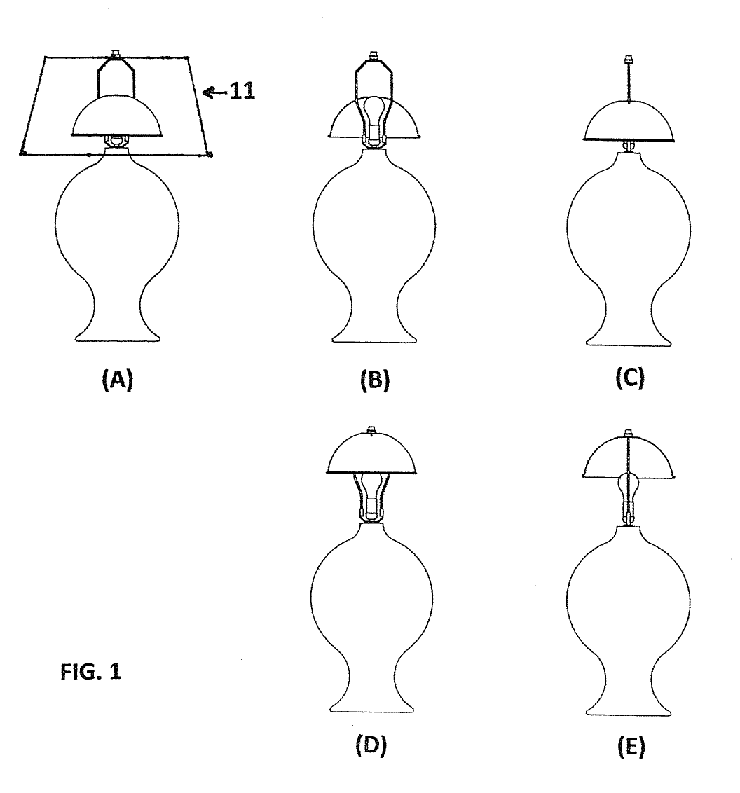

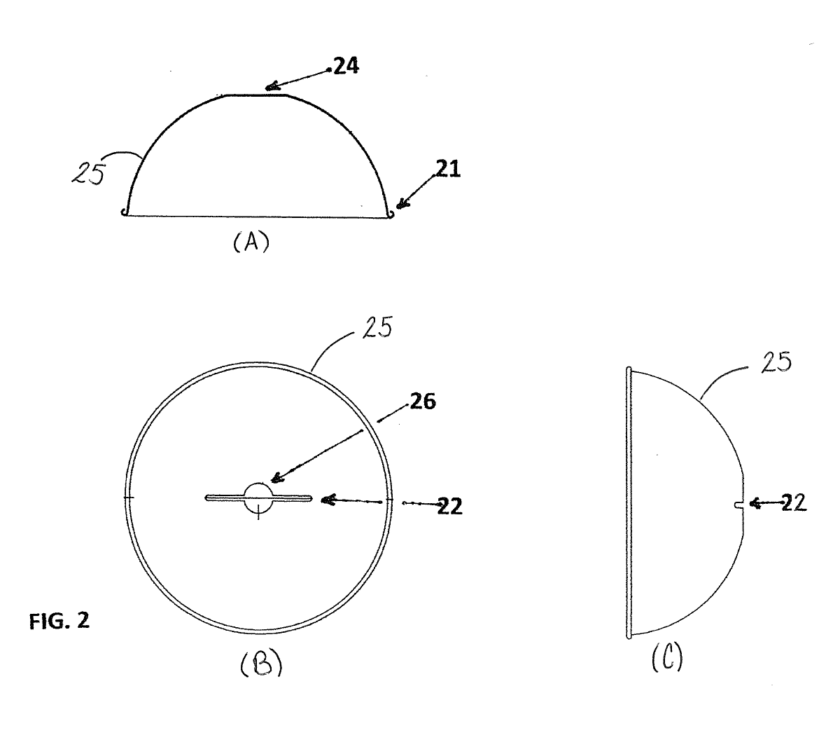

FIG. 2A shows a horizontal side view, FIG. 2B shows a top view, and FIG. 2C shows a vertical side view of an exemplary LLDR, according to some embodiments of the present invention. As shown, a LLDR having a housing 25 substantially in the shape of a half-sphere that can be made of aluminum, steel, copper, plastic and/or glass with a reflective surface. The shape of the housing may be any shape suitable to reflect light on its interior surface. The housing 25 has a convex exterior surface and a convex reflective interior surface. The top portion of the exterior surface includes a hole 26 configured to accommodate a harp nut base 32 of the lamp, and a slit 22 configured to accommodate a harp of the lamp. The housing 25 is configured to be installed on the lamp such that the reflective interior surface faces the light bulb of the lamp, as shown in FIGS. 1A-1E. Moreover, the housing is configurable to be installed on the lamp in multiple positions, as shown in FIGS. 1B and 1E and explained in more detail below.

In some embodiments, the LLDR has a rolled edge 21 at its edge for safety reasons, as shown in FIGS. 2A to 2C. The rolled edge 21 prevents the users from cutting themselves while changing the position of the LLDR. In some embodiments, the top area of the LLDR includes a flat area 24 for allowing the LLDR to rotate under the lamp shade base area and around the lamp harp nut base. The LLDR also includes a cut opening/slit 22 to allow the LLDR to slide up or down the lamp harp or rest on top of the lamp harp. In operation, when the LLDR is installed on a lamp, its inner surface which is situated above the lamp bulb reflects the majority of the light produced by the lamp bulb downward towards the base of the lamp.

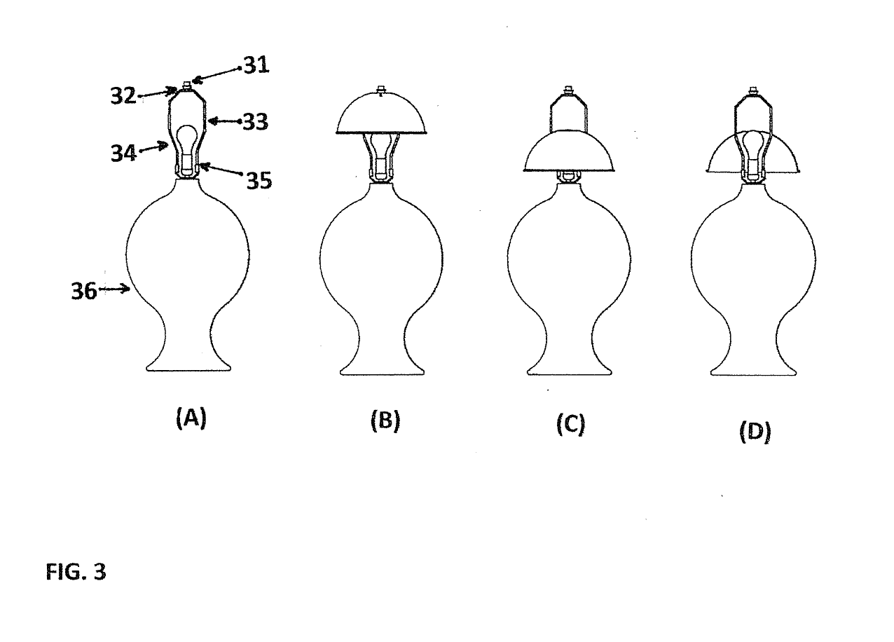

FIG. 2B shows the opening (hole) 26 for the lamp harp nut base (32 in FIG. 3A) to pass through. The diameter of the lamp harp passes through the cut opening/slit 22, when placing LLDR into a second position. The cut opening/slit 22 allows the lamp harp to slide on the LLDR and the lamp harp nut base to rotate inside.

In some embodiments, the LLDR of the present invention rests on the top of the lamp harp and below the lamp shade base and can be slid up or down the lamp harp then resting on top of the lamp bulb, as shown in FIGS. 1A, 1B, 1C, 1D, 1E, 3B, 3C and 3D. In some embodiments, the LLDR according to the present invention has few positions of operation, for example, two positions, as shown in FIGS. 1A, 1B, 1C, 1D, 1E, 3B, 3C and 3D. The first position is at the top of the lamp harp (resting upon the top of the lamp harp) and the other resting atop the lamp bulb. Test results show that the closer the LLDR is to the lamp bulb, the higher the intensity of light that is redirected to the base of the lamp. The LLDR of the present invention thus allows the user to have a choice of two intensities of light from the same lamp bulb redirected to the base of the lamp.

FIGS. 3A-3D show an exemplary installation of a LLDR on a lamp, according to some embodiments of the present invention. To install the LLDR according to some embodiments, the lamp nut 31 securing the lamp shade 11 (shown in FIG. 1A) to the lamp harp 33 is unscrewed and removed from the harp nut base 32. The lamp shade can then be removed from the lamp harp 33. The LLDR is then placed onto the lamp harp 33, in such a way that the harp nut base 32 is put through the hole 26 of the housing 25. The lamp shade 11 is placed back on the lamp harp, and the lamp nut 31 is screwed back to the harp nut base 32. The design of the LLDR allows for multiple positioning on the lamp, depending on what intensity of light the user chooses to use.

In some embodiments, there are multiple positions for the LLDR. An example of two positions for the LLDR is shown in FIGS. 1B and 1E. Position one (shown in FIG. 1D and in FIG. 3B) is at the top of the lamp harp. In this position, slots in the appliance are not aligned with the lamp harp, which prevents the LLDR from sliding down the lamp harp and rests on the top of the lamp harp. To place the LLDR into the second position (shown in FIGS. 1B and 3D), the user reaches under the existing lamp shade and rotates the LLDR so the slots in the LLDR line up with the lamp harp which allows the LLDR to slide down the lamp harp and rest upon or close to the lamp bulb, as shown in FIGS. 1A, 1B, 1C, 3C and 3D. Second position provides a higher amount of light to the base of the lamp when compared to the first position, because of the closeness of the LLDR to the lamp bulb.

To replace the LLDR into position one, the user reaches under the existing lamp shade, gently grabs the LLDR and lifts it upward sliding on the lamp harp until it reaches the top of the lamp harp, and then twists the LLDR 180 degrees so the LLDR slots do not line up with the existing lamp harp. By doing this, the LLDR will rest upon the top of the lamp harp. LLDR.

The present invention redirects a majority of the light generated by the lamp bulb to the base of the lamp rather than unto the lamp shade and/or above the lamp. By redirecting the light produced by the lamp bulb using the LLDR, the user will observe increased amounts of light ranging from 200% to over 500% to the base of the lamp. Testing showed that a forty (40) watt incandescent bulb utilizing the LLDR provided higher amounts of light to the base of the lamp when compared to a 100 watt incandescent bulb without utilizing a LLDR in the identical lamp setting.

The LLDR according to the present invention is an energy saving device, which allows the users to use lower wattage bulbs to accomplish their lighting requirements to the base of their lamps, rather than using a higher wattage light bulb. The LLDR is easy to install, change positions, lightweight, safe, and is hidden from sight by the existing lamp shade.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope and spirit of the invention. For example, the shape, or material of the LLDR may vary without impacting the utility and application of the invention.

What is claimed is:

1. A lamp light director reflector for being installed on a lamp having a light bulb comprising:
a housing having a convex exterior surface and a convex reflective interior surface;
a hole on a top portion of the exterior surface configured to accommodate a harp nut base of the lamp therein, in a first position; and
a slit on the top portion of the exterior surface configured to accommodate a lamp harp of the lamp therein, in a second position wherein the housing is configured to be installed on the lamp such that the reflective interior surface faces the light bulb of the lamp, wherein the first position is at a top of the lamp harp resting upon the harp, and wherein the lamp harp passes through the slit in the second position resting atop the lamp harp.

2. The lamp light director reflector of claim 1, wherein the slit is configured to allow the lamp harp to slide through the slit when in the second position.

3. The lamp light director reflector of claim 1, wherein the top portion of the exterior surface includes a flat area for allowing the lamp light director reflector to rotate on top of the harp and around the harp nut base.

4. The lamp light director reflector of claim 1, further comprising a rolled edge at an edge of the housing.

5. The lamp light director reflector of claim 1, wherein the housing is substantially in a shape of a half-sphere.

6. The lamp light director reflector of claim 1, wherein the housing is substantially made of one of group consisting of aluminum, steel, copper, plastic, and glass with a reflective surface.

7. A lamp light director reflector for being installed on a lamp having a light bulb, a harp and a harp nut base comprising:
a housing substantially in a half-sphere shape and having an exterior surface and a reflective interior surface;
a hole on a top portion of the exterior surface configured to accommodate the harp nut base of the lamp and
a slit on the top portion of the exterior surface including the hole and configured to accommodate the harp of the lamp therein, wherein the housing is configured to be installed on the lamp such that the reflective interior surface faces the light bulb of the lamp, and wherein the slit and hole are configured to allow the lamp light director reflector to slide up or down the lamp harp.

8. The lamp light director reflector of claim 7, wherein the hole and the slit are configured to allow the housing to be positioned in a first position and a second position on the lamp, wherein the first position is at a top of the lamp harp resting upon the harp nut base, and wherein the lamp harp passes through the slit in the second position.

9. The lamp light director reflector of claim 7, wherein the top portion of the exterior surface includes a flat area for allowing the lamp light director reflector to rotate on top of the harp.

10. The lamp light director reflector of claim 7, further comprising a rolled edge at an edge of the housing.

11. The lamp light director reflector of claim 7, wherein the housing is substantially made of one or more of group consisting of aluminum, steel, copper, plastic, and glass, with a reflective inner surface.
